(19) United States
(12) Patent Application Publication
(10) Pub. No.: US 2005/0124287 A1
(43) Pub. Date: Jun. 9, 2005

(54) Cellphone stabilization of EDM instruments

(75) Inventor: James M. Janky, Los Altos, CA (US)

Correspondence Address: LAW OFFICES OF THOMAS E. SCHATZEL;A professional Corporation, Suite 240, 16400 Lark Avenue, Los Gatos, CA, 95032-2547, US

(73) Assignee: Trimble Navigation Limited

(21) Appl. No.: 10/732,124

(22) Filed: Dec. 9, 2003

(51) Int. Cl. H04H 9/00

(52) U.S. Cl. 455/2.01; 455/427; 455/230

(57) ABSTRACT

An electro-optical total station system includes an EDM reference oscillator trained and disciplined by reference frequency standard information derived from local cellular telephone base station transmission carriers.

### BACKGROUND OF THE INVENTION

1. Field of the Invention

The present invention relates generally to surveying instruments, and more particularly to using reference signals obtained from cellular telephones and systems to automatically and precisely calibrate electronic distance measurement instruments.

2. Description of the Prior Art

Electronic distance measurement (EDM) equipment became commercially available after World War-II and has since become very important to land surveying, navigation and scientific study. Since the introduction of EDM, the instrument size and power consumption have been reduced, and the precision and speed of measurement have been improved. Because the miniaturization of EDM equipment became possible, it made good sense to mount EDM's on theodolites which have telescopes that can precisely sight a horizontal and vertical angle to a target. Such combinations are electro-optical hybrids called “total stations.”

Combination electronic theodolite and EDM instruments allow surveyors to find the “space vector” from the instrument to a distant target. When a total station is connected to an electronic data recorder, field information can be quickly gathered and used to generate maps and plans in the office.

Flexible tapes, leveling staves, electro-optical distance meters, and other surveying equipment are calibrated to a legal standard and calibration certificates are issued, e.g., a “Regulation 80 Certificate,” as is issued in Western Australia. Such calibration is especially important where a legal purpose is in mind, e.g., an inspection to enforce a law or to be used as evidence in a court action. A flexible tape calibration laboratory in Midland is registered by the National Standards Commission of Australia for calibration of 1-100 meter lengths.

There are two certified baselines in Western Australia against which EDM instruments can be calibrated. The aim of EDM calibration is to ensure that it measures in accordance with the internationally recognized definition of length, as set forth by the Conference Generale des Poids et Measures (CGPM—the General Conference on Weights and Measures). Other governments in the world provide similar baselines and certification opportunities. When a Regulation 80 Certificate is required for the purpose of legal traceability to the Australian Standard for length, the EDM instrument is submitted to the Surveyor General for calibration. The Director of the Mapping & Survey Division is the verifying authority for length and is appointed by the National Standards Commission. The Surveyor General now provides a software application program, called BASELINE, to assist surveyors with their regular calibrations of EDM instruments.

The accuracy of electronic distance measurement equipment is derived from an internal reference frequency source, e.g., a crystal oscillator. But such crystal oscillators can drift over time and with age. Exposure to extreme environments can also upset delicate calibrations of the reference frequency source, both short term and long term. Therefore, EDM equipment should be regularly calibrated by using it to measure a known length.

Long-range electronic distance meters, e.g., ranges over five kilometers, typically use microwave signals for measurement. Short range electronic distance meters often use infrared light. See, Rueger, J. M., Electronic Distance Measurement—An Introduction, Springer Verlag, Berlin, third edition, 1990. Both the long-range and short-range EDM's use pulse or phase comparison methods to determine the distance between instrument and a remote target. However, the phase comparison method is more commonly used for survey instruments.

The pulse technique is based on timing the signal travel time to and from a distant reflector. The velocity of the signal is assumed to be known. For phase comparison, the phase difference of signals is observed at several frequencies. The unambiguous distance between the target and the instrument is resolved using phase difference observations. But in all cases, the basis for measurement precision depends on the accuracy of the stand-alone reference frequency source.

### SUMMARY OF THE PRESENT INVENTION

It is therefore an object of the present invention to provide an electronic distance measurement which is automatically and precisely calibrated.

Briefly, an electro-optical total station system embodiment of the present invention includes an EDM reference oscillator trained and disciplined by reference frequency standard information derived from local cellular telephone base station transmission carriers.

An advantage of the present invention is that an electro-optical total station system is provided that remains automatically calibrated.

These and other objects and advantages of the present invention will no doubt become obvious to those of ordinary skill in the art after having read the following detailed description of the preferred embodiment that is illustrated in the drawing figure.

### IN THE DRAWINGS

FIG. 1 is a functional block diagram of electronic distance measurement (EDM) system embodiment of the present invention;

FIG. 2 represents a plot of short-term oscillator drift and the effect of the present invention to correct long-term oscillator drift;

FIG. 3 is a functional block diagram of a total station which uses an external reference oscillator that is stabilized by a timing signal obtained from a cellphone receiver; and

FIG. 4 is a functional block diagram of a 10 MHz reference oscillator in a generic product that is locally stabilized or disciplined by a cellphone receiver with zero-crossing comparisons at one pulse per second.

### DETAILED DESCRIPTION OF THE PREFERRED EMBODIMENT

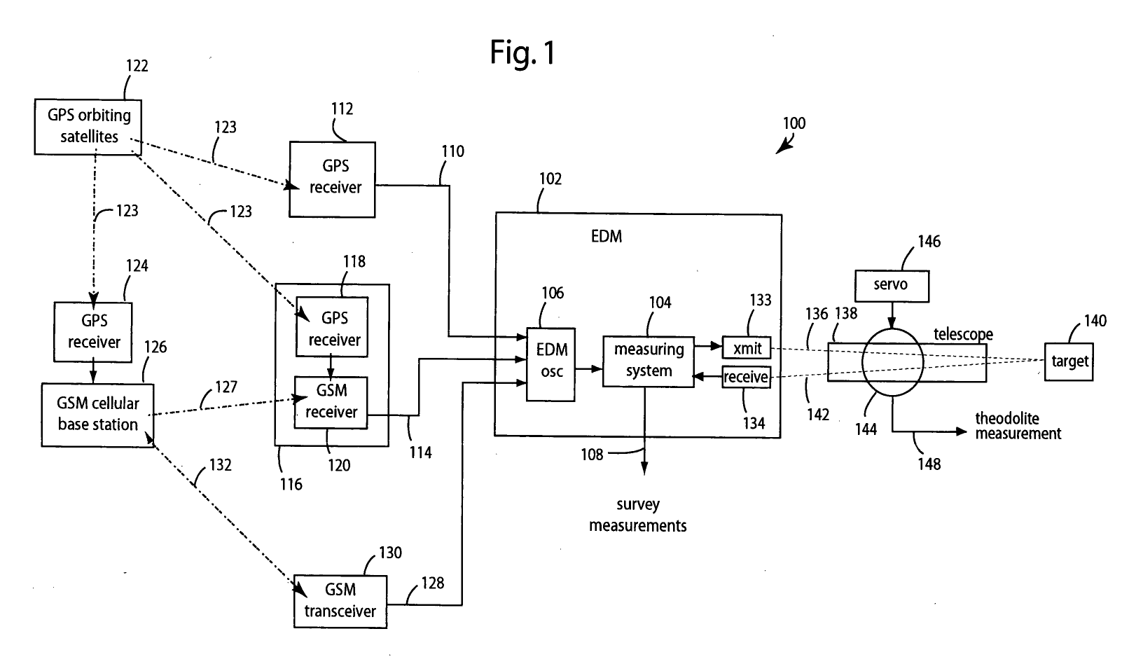

FIG. 1 represents a electronic distance measurement (EDM) system embodiment of the present invention, referred to herein by the general reference numeral 100. Such system 100 derives calibration information and signals from opportunistic reference-frequency-standard sources like the GPS navigation system and cellular telephone network transmissions. These sources are not used for their intended purposes, e.g., user navigation or communication.

At least three types of cellular phone networks have been in widespread use, e.g., analog mobile phone system (AMPS) which uses FM radio links, time division multiple access (TDMA), and code division multiple access (CDMA). The TDMA and CDMA have become dominant lately. TDMA is the basis for the PCS systems used in the United States and the Global System for Mobile Communications (GSM) used everywhere else. The PCS system uses the 1850 MHz frequency band in the United States.

An EDM instrument 102 includes a distance measuring system 104 that depends on a very accurate EDM oscillator 106. The EDM instrument 102 can be associated with a theodolite, and such combination is commonly referred to as a total station.

GSM phones generally synchronize an internal reference oscillator to the incoming pilot signal transmitted by the cell tower transmitter. The relatively high carrier frequency is down converted to either 13.00 or 26.00 MHz. This downconverted signal is tapped into for the reference for the EDM.

The measuring system 104 includes an EDM transmitter for launching an out-bound signal to a distant target and an EDM receiver for receiving a reflected signal from the distant target. A phase measurement device is connected to the reference oscillator and to both said EDM transmitter and EDM receiver and provides for a time measurement of the difference between the out-bound and reflected signals. A distance-to-target measurement can then be computed.

The accuracy of EDM oscillator 106 directly impacts the precision of output survey measurements 108. For example, the measuring system 104 can include a laser ranging device that reflects a laser light pulse from a distant target and that measures the time-of-flight of the laser pulse to determine the range distance.

The EDM oscillator 106 can be trained, disciplined, locked, or otherwise calibrated to a precision reference frequency output 110 from a GPS navigation receiver 112. For example, a 10.0 MHZ or 1.0 PPS output that is inherently locked to the atomic standards intrinsic in the GPS Navigation System.

The EDM oscillator 106 may also be trained, disciplined, locked, or otherwise calibrated to a precision reference frequency output 114 from a disciplined clock 116. Such includes a GPS receiver 118 and a GSM-type cellular telephone receiver 120. A regular cellphone transceiver is not required in this instance, so GSM-type cellular telephone receiver 120 need not necessarily be a subscriber to mobile phone services. The disciplined clock 116 has the advantage of higher “up-time”, in that it can provide precision reference frequency output 114 if only one of GPS signals 123 or cellular signals 127 are being received. Extrapolated corrected-time is also possible during periods of brief outages of both signals.

Embodiments of the present invention do not necessarily depend on the use of GSM-type cellular telephone receivers. Other types of cellular telephone networks can provide the requisite frequency standard signals in the outbound transmissions of their base stations. GSM and other CDMA cellular network base stations operate with high stability carriers on the order of 0.05 parts-per-million (ppm), see industry standard specification “GSM 05.10”. Published articles have cited a 0.1 ppm limit for handheld cellular units.

In general, a standard cellular telephone handset is adapted to take a timing signal referenced to the outbound transmissions of a cellular telephone base station. Such is converted and conditioned to a frequency or pulse-per-second (PPS) usable by the EDM instrument 102. The signal is typically brought to an external connector that allows it to be easily cabled to the EDM oscillator 106.

The implementation of embodiments of the present invention by the reader may be assisted by studying a description of how GSM signal transmissions can be used to help initialize a GPS navigation receiver. See, U.S. Pat. No. 6,122,506, issued Sep. 19, 2000, to Lau, et al. Also see, Eschenbach, et al., U.S. Pat. No. 5,663,735. And see, U.S. Pat. No. 5,841,396, issued to Norman Krasner on Nov. 24, 1998.

A constellation of orbiting GPS satellites 122 transmit signals 123 with very precise timing and frequency underpinnings. Precise, sub-microsecond reference standards can be derived from such signals by GPS receivers 112, 118, and 124. A GSM cellular base station 126, in fact, relies on GPS receiver 124 to provide a disciplined clock to operate effectively.

The precision inherent in GPS signal transmissions 123 is, in-part, passed on in the cellular telephone communication signals 127 transmitted by GSM cellular base station 126. The GSM-type cellular telephone receiver 120 is able to recapture this precision, and passes it along to EDM oscillator 106.

A third alternative reference standard 128 is provided by a regular GSM-type cellphone 130. Such is adapted to provide, for example, a precise 10.0 MHz output with timing accuracy derived from a two-way cellular telephone link 132. The timing accuracy is derived provided by the GPS receiver 124 through the GSM cellular base station 126.

The EDM part of the system 100 includes a transmitter 133 and a receiver 134. An out-bound signal 136 is directed through a telescope 138 to a distant target 140. The target 140 may include a prism corner-cube reflector, or active repeater for microwave EDM, to return an in-bound signal 142. The signals 136 and 142 may be infrared or other laser light, or microwave signals. The EDM phase measurement subsystem 104 can conduct either pulse time-of-flight or carrier phase measurements to determine the line-of-sight distance to the target 140. Conventional methods and equipment can be used to do this. A target range measurement 108 is output that can be presented on a local display, recorded electronically, or transmitted to a user that is at the target and is moving the target around to mark a particular range from the system 100 location.

A theodolite part of the system 100 includes the telescope 138 mounted to an angle measurement instrument 144 connected to a servo actuator 146. A theodolite measurement 148 includes an elevation and azimuth output that can be presented on a local display, recorded electronically, or transmitted to a user that is at the target 140 and is moving the target around to mark a particular vector angle from the system 100 location. A space vector to target signal is computed.

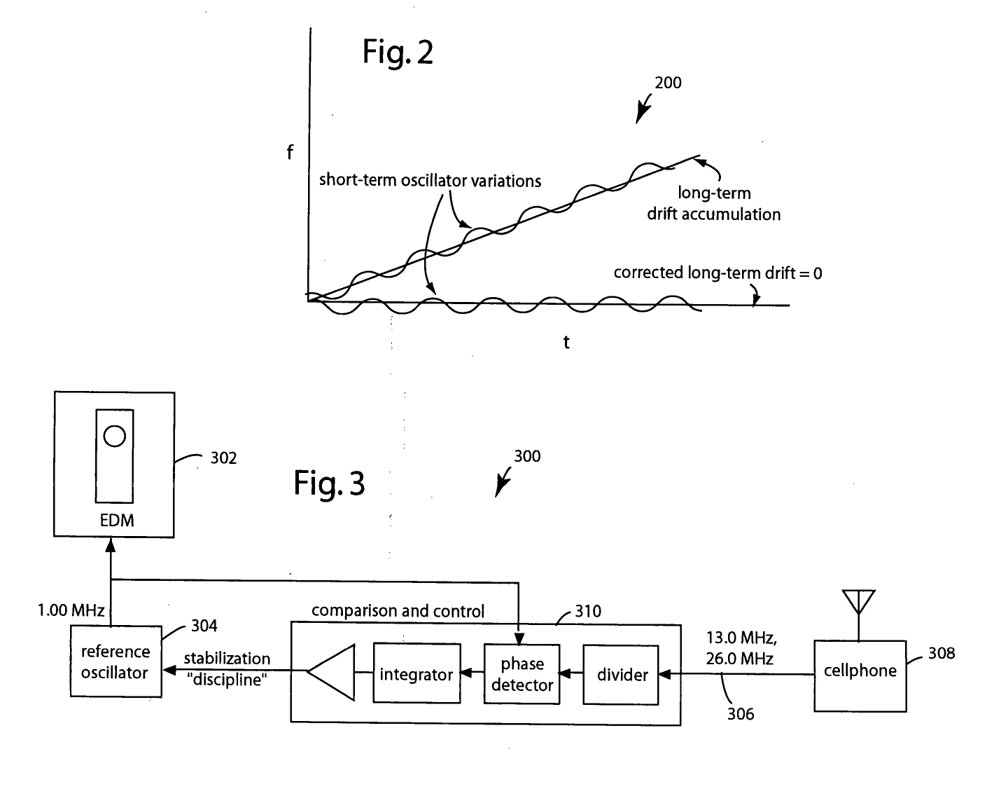

FIG. 2 represents a plot of short-term oscillator drift and the effect of the present invention to correct long-term oscillator drift.

FIG. 3 illustrates a system 300 in which an EDM 302 inputs a 1.00 MHz precision reference oscillator 304 that is stabilized by a timing signal 306 derived from a cellular telephone receiver 308. A divider reduces the frequency used from either 13.00 MHz or 26.00 MHz. A phase comparison and frequency control circuit 310 makes minor corrections in the operating frequency of oscillator 304. Such reference oscillator may be a voltage-controlled oscillator (VCO) or a numeric controlled oscillator (NCO) type. For the VCO type, the control signal from circuit 310 is a variable analog voltage or current. For the NCO type, the control signal from circuit 310 is a digital value.

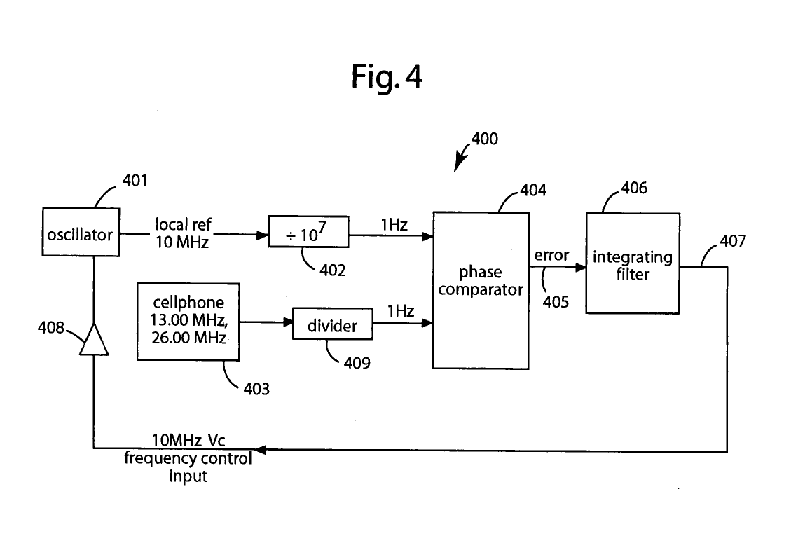

FIG. 4 shows a precision reference system 400 in which a 10.00 MHz reference oscillator 401 is a generic product that is stabilized or disciplined by zero-crossing comparisons at one pulse per second. A divider 402 is used to reduce the output of the oscillator 401 to 1.00 Hz. A local cellphone receiver source 403 provides a reference 1.00 Hz signal that is exceedingly precise and stable, e.g., because it is derived from atomic clocks. A phase comparator 404 provides an error signal 405 that is applied to an integrating filter 406 that drives the static phase error to zero for synchronization. A control signal 407 is returned via a buffer 408 to the oscillator 401. A divider 409 reduces the frequency tapped from cellphone 403 from either 13.00 MHz or 26.00 MHz. The overall effect is to reduce the accumulation of errors over the long term to an average of zero, as in FIG. 2.

Although the present invention has been described in terms of the presently preferred embodiment, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

1. A surveying instrument, comprising:
an electronic distance meter (EDM) having an EDM transmitter for launching an out-bound signal to a distant target and an EDM receiver for receiving a reflected signal from said distant target;
a phase measurement device connected to the reference oscillator and to both said EDM transmitter and EDM receiver and providing for a time measurement of the difference between said out-bound signal and said reflected signal from which a distance-to-target measurement can be computed;
a reference oscillator that provides a timing basis for the phase measurement device and that can be trained by an external precision frequency standard; and
a cellphone connected to receive cellular telephone base station transmissions and to extract there from frequency stabilization information for use by the reference oscillator.

2. The surveying instrument of claim 1, further comprising:
a theodolite with a telescope connected to the EDM and an angle measurement instrument mechanism that together can determine an elevation and an azimuth to said distant target.

3. The surveying instrument of claim 1, wherein:
the cellphone is a receiver only and is not necessarily a commercial subscriber to any service provided by said cellular telephone base station.

4. The surveying instrument of claim 1, wherein said cellphone and cellular base station operate according to the GSM industry standard.

5. A method of automatically calibrating an electronic distance meter, comprising the steps of:
deriving precise time information from externally generated cellular telephone base station radio transmissions;
correcting a local reference clock for an EDM with a signal obtained in the step of deriving; and
measuring a time phase difference between an out-bound signal and an in-bound signal reflected by a distant surveyor target using a reference time-base obtained from said local reference clock.

6. The method of claim 5, wherein:
the step of deriving includes the use of a cellphone receiver.

7. The method of claim 6, wherein:
the step of measuring said time phase difference includes observations of a plurality of phase differences observed by said electronic distance meter at a plurality of out-bound and in-bound signal frequencies.

8. The method of claim 6, further comprising the steps of:
automatically providing a target range measurement to a user at said distance target by said electronic distance meter; and
automatically providing a vector angle measurement to said user to said distant target obtained by a theodolite.

9. A surveying instrument, comprising:
a satellite navigation receiver;
a cellular telephone base station having its transmissions frequency referenced from signals obtained from the satellite navigation receiver;
a cellular telephone receiver able to provide frequency reference information based on signal transmissions it receives from the cellular telephone base station;
a reference oscillator with a frequency offset that is controlled by information provided from the cellular telephone receiver;
an electronic distance meter having an EDM transmitter for launching an out-bound signal to a distant target and an EDM receiver for receiving a reflected signal from said distant target; and
a phase measurement device connected to the reference oscillator and to both said EDM transmitter and EDM receiver and providing for a measurement of the difference in time between said out-bound signal and said reflected signal from which a distance-to-target measurement can be computed.

10. A surveying instrument, comprising:
a satellite navigation receiver;
a cellular telephone base station having its transmissions frequency referenced from signals obtained from the satellite navigation receiver;
a cellular telephone receiver able to provide frequency reference information based on signal transmissions it receives from the cellular telephone base station;
a reference oscillator with a frequency offset that is controlled by information provided from the cellular telephone receiver, and wherein a determination of said frequency offset is used later in software to correct for frequency errors;
an electronic distance meter having an EDM transmitter for launching an out-bound signal to a distant target and an EDM receiver for receiving a reflected signal from said distant target; and
a phase measurement device connected to the reference oscillator and providing for a distance-to-target measurement computed from said determination of said frequency offset in software to correct for errors;
wherein, a calibration signal provided to the phase measurement device enables an automatic and continuous calibration in software of distance-to-target measurements.
